(19) United States
(12) Patent Application Publication
(10) Pub. No.: US 2006/0224759 A1
(43) Pub. Date: Oct. 5, 2006

(54) System and method for a peer-to-peer streaming content operation by a browser plug-in

(75) Inventors: Han Fang, Beijing (CN); Xiangyang Chen, Beijing (CN); Xin Yu, Beijing (CN)

Correspondence Address: HAYNES AND BOONE, LLP, 901 MAIN STREET, SUITE 3100, DALLAS, TX, 75202, US

(73) Assignee: 1000 Oaks Hu Lian Technology Development Co., Ltd., Beijing (CN)

(21) Appl. No.: 11/202,443

(22) Filed: Aug. 12, 2005

Related U.S. Application Data
(60) Provisional application No. 60/662,131, filed on Mar. 15, 2005.

(51) Int. Cl. G06F 15/16

(52) U.S. Cl. 709/231

(57) ABSTRACT

A method, computer-readable medium and system for configuring a network client as a peer client in a peer-to-peer network is provided. A network client connects with a network node and obtains a data structure that includes plug-in code from the network node. The network clients installs a plug-in from the plug-in code. The plug-in connects with a control server of the peer-to-peer network and receives connectivity information of one or more nodes of the peer-to-peer network. The plug-in connects with at least one of the one or more nodes.

### RELATED APPLICATION DATA

This patent application claims the benefit of provisional U.S. patent application Ser. No. 60/662,131, filed Mar. 15, 2005.

### BACKGROUND

In a client-server network adapted to provide streaming multimedia services such as streaming video or audio, many clients may participate in a video streaming session. The processing capacity of a media server in such a network is limited. If the number of clients connected to the media server exceeds the processing or transmission capacity of the server, the media server may be unable to provide a high quality of service to the clients, crash, discontinue service to clients, or refuse service or connection to clients.

Service problems associated with excessive loads placed on a streaming source in a client-server network have conventionally been addressed by deploying multiple servers in the client-server network. For example, multiple servers may be deployed in a cluster mode such that connecting clients are unaware of the multiple servers providing the streaming content. However, cluster mode server configurations can only provide improved streaming service quality from a processing performance standpoint. Problematically, streaming service deficiencies related to transmission capacity are not addressed by cluster mode solutions in a client-server network.

### BRIEF DESCRIPTION OF THE DRAWINGS

Aspects of the present disclosure are best understood from the following detailed description when read with the accompanying figures, in which:

FIG. 1 is a diagrammatic representation of an embodiment of a network that facilitates streaming content operation;

FIG. 2 is a diagrammatic representation of an embodiment of a software configuration that facilitates connection of a client with a network and configuration of the client for streaming content in a peer-to-peer network;

FIG. 3 is a diagrammatic representation of an embodiment of a data structure that may be provided to clients of a network that facilitates joining the clients with a peer-to-peer network;

FIG. 4 is a diagrammatic representation of an embodiment of a software configuration that facilitates streaming content operation in a peer-to-peer network;

FIG. 5 is a diagrammatic representation of an embodiment of a plug-in configuration that facilitates streaming content operation in a peer-to-peer network;

FIG. 6A is a diagrammatic representation of an embodiment of segmented streaming content;

FIG. 6B is a diagrammatic representation of an embodiment of segmented streaming content encapsulated in a peer-to-peer transport packet that may be distributed within a peer-to-peer network; and

FIG. 7 is a flowchart of a configuration processing routine for configuring a network client as a peer client adapted for streaming content operation in a peer-to-peer network.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

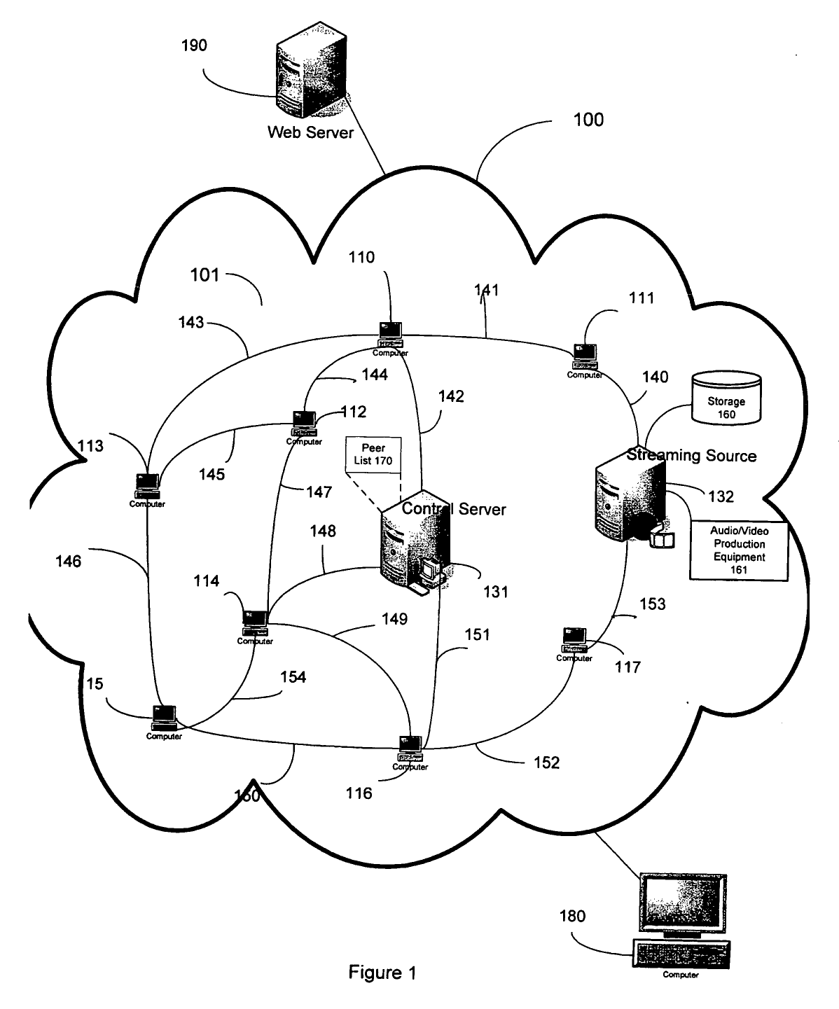

FIG. 1 is a diagrammatic representation of an embodiment of a network that facilitates streaming content operation. In the illustrative examples provided herein, network 100 is implemented as the Internet although other network configurations, such as local area networks, wide area networks, propriety networks, or other network configurations suitable for facilitating communications among various data processing systems, may be suitably substituted therefor. A web server 190 is interconnected with network 100 and provides web content, such as HTML pages or other data structures, to clients, such as Internet protocol (IP) client 180, connected with network 100.

Additionally, other network systems may be deployed on network 100. In the illustrative example, a peer-to-peer network 101 (illustratively encompassed with dashed lines) run over IP is deployed in network 100. Peer-to-peer network 101 includes various peer clients 110-117 that may be interconnected with other clients in network 101. Additionally, network 101 may include a control server 131 and a streaming source 132. One or more peer clients may connect with control server 131 and streaming source 132 in addition to other network clients. Clients 110- 117 may connect with other network clients, control server 131 and streaming source 132 by network connections 140-154, such as wire, wireless communication links, fiber optic cables, or other suitable network media.

Control server 131 may facilitate connection of new clients within network 101 and organize clients 110-117 that have joined network 101. Clients 110-117 may be implemented as data processing systems, such as personal computers, wired or wireless laptop computers, personal digital assistants, or other computational devices capable of network communications.

Streaming source 132 may be implemented as a server that stores or accesses streaming content, such as video, audio, or the like, and streams the data to one or more clients in network 101. For example, the streaming content may be retrieved from a file that is accessed by streaming source 132 from a storage device 160. Alternatively, the streaming content may be produced from, for example, audio/video production equipment 161 that is interfaced with streaming source 132. The streaming content may comprise data encoded in a native streaming format, such as RealAudio formatted files, RealVideo formatted files, advanced streaming format (ASF), or another streaming format that may be processed by a streaming media application, such as RealPlayer, Windows Media Player, or another streaming media application. Streaming source 132 may segment streaming content into data blocks that are distributed within network 101. The native formatted streaming content may be encapsulated in a network transport format that facilitates transmission of data among peer clients of network 101. Various clients 110-117 may receive and store different data blocks of the streaming content.

Control server 131 maintains a peer list 170 that includes connectivity information, such as a network address and port number, of respective peer clients that are connected within peer-to-peer network 101. When control server 131 generates peer list 170, connectivity information of streaming source 132 may be the only connectivity information included in peer list 170. A client joins peer-to-peer network 101 by first connecting with control server 131 and submitting a request for peer list 170. The control server returns peer list 170 to the requesting client, and the client joins network 101 by selecting one or more nodes having connectivity information included in peer list 170 and connecting with the selected nodes.

When a new client joins peer-to-peer network 101, control server 132 may add connectivity information of the newly joining client to peer list 170. In this manner, as additional clients join peer-to-peer network 101, the availability of peer clients with which subsequently joining clients may connect is increased. Connectivity information of streaming source 132 may be removed from peer list 170, for example when the number of clients connected within peer-to-peer network 101 reaches a pre-defined threshold. In this manner, the streaming session load placed on streaming source 132 may be reduced. A client connected within peer-to-peer network 101 that desires streaming content originally provided by streaming source 132 may submit a query for the streaming content to peer clients with which the requesting client is connected. If no peer clients within network 101 have the requested streaming content (or no peer clients within network 101 are available for delivery of the streaming content to the requesting client), the requesting client may obtain the streaming content from streaming source 132.

A peer client that receives streaming content from streaming source 132 may be configured to cache or temporarily store the streaming content (or a portion thereof) for playback. Additionally, a client may distribute cached streaming content to other peer clients. Streaming content may be segmented by streaming source 132 into data blocks that each have an associated sequence number. Playback of streaming content is performed by arranging data blocks into a proper sequence based on the data blocks' sequence numbers. A tracking server 133 may be deployed within network 101 for monitoring the sequence numbers of particular data blocks maintained by respective clients within peer-to-peer network 101. Tracking server 133 may facilitate identification of clients having particular data blocks of streaming content for which a request is made by other peer clients.

In the illustrative example, network 101 comprises a transient Internet network, and thus clients 110-117, control server 131, and streaming source 132 may use the Transmission Control Protocol/Internet Protocol (TCP/IP) suite of protocols to communicate with one another. Alternatively, network 101 may be implemented in any number of different types of networks, such as for example, an intranet, a local area network (LAN), or a wide area network (WAN). Additionally, control server 131 and streaming source 132 are shown as distinct entities within network 100. However, control server 131 and streaming source 132 may be collectively implemented in one or more common network nodes. FIG. 1 is intended as an example, and not as an architectural limitation of embodiments described herein.

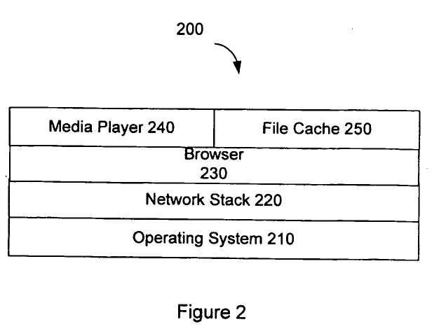

FIG. 2 is a diagrammatic representation of an embodiment of a software configuration 200 that facilitates connection of a client with network 100 and configuration of the client for streaming content in peer-to-peer network 101. Software configuration 200 comprises sets of computer-executable instructions or code that may be fetched from a memory and executed by a processing unit of a data processing system. Software configuration 200 is preferably run by an Internet client, such as client 180 shown in FIG. 1.

Software configuration 200 may include an operating system 210, such as a Windows operating system manufactured by Microsoft Corporation of Redmond, WA, an OS/2 operating system manufactured by International Business Machines Corporation of Armonk, NY, or the like. Operating system 210 may include a network stack 220 for effecting network communications. For example, network stack 220 may be implemented as a TCP/IP stack.

Software configuration 200 may include a browser 230 application that comprises logic for interacting with network 100. For example, browser 230 may include a graphical user interface and logic for interpreting web content, such as HTML pages, and displaying web content in the graphical user interface. Browser 230 may be implemented as, for example, Microsoft Internet Explorer, Netscape Navigator, Mozilla, or another suitable Internet browser.

Additionally, software configuration 200 may include a media player 240, such as RealPlayer, Windows Media Player, or another media player application, that comprises logic for processing and playback of streaming data, such as streaming video, audio, or other streaming content. Media player 240 may interface with a file cache 250 that may be of a fixed size, for example 50 MB. File cache 250 may be implemented in a client storage device, such as a random access memory, a disk drive, or another suitable storage medium.

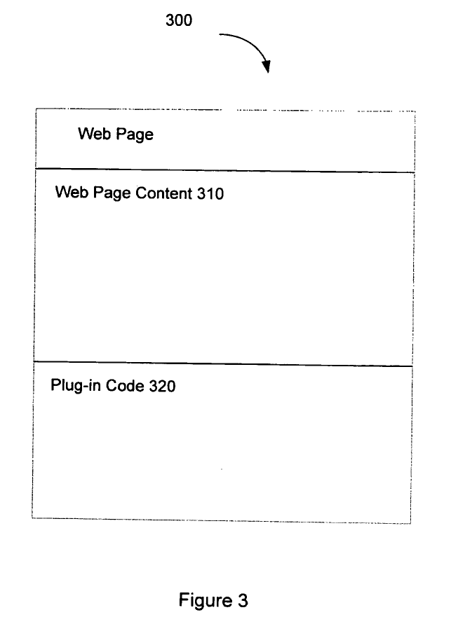

FIG. 3 is a diagrammatic representation of an embodiment of a data structure 300 that may be provided to clients of network 100 that facilitates joining clients with peer-to-peer network 101. Data structure 300 may be implemented as a web page, such as an HTML document, and includes web page content 310. Web page content 310 may be parsed from data structure 300 by web browser 230 and displayed on a display device. Additionally, data structure 300 may include plug-in code 320 that is embedded within web page content 310. Plug-in code 320 comprises logic for interfacing with browser 230 and that extends the functionality of browser 230. Plug-in code 320 may be implemented as, for example, ActiveX, Java Applet, XPCOM, or other suitable logic for extending the functionality of browser 230. In a preferred embodiment, web page content 310 includes a parameter or other control code that, when processed by web browser 230, activates plug-in code 320.

Web server 190 may provide data structure 300 to data processing systems connected with network 100. For example, client 180 may connect with web server 190 via network 100 and download data structure 300 therefrom. Processing of data structure 300 results in invocation of plug-in code 320. In accordance with embodiments described herein, plug-in code 320 extends the functionality of web browser 230 for operation of streaming content within a peer-to-peer network as described more fully below.

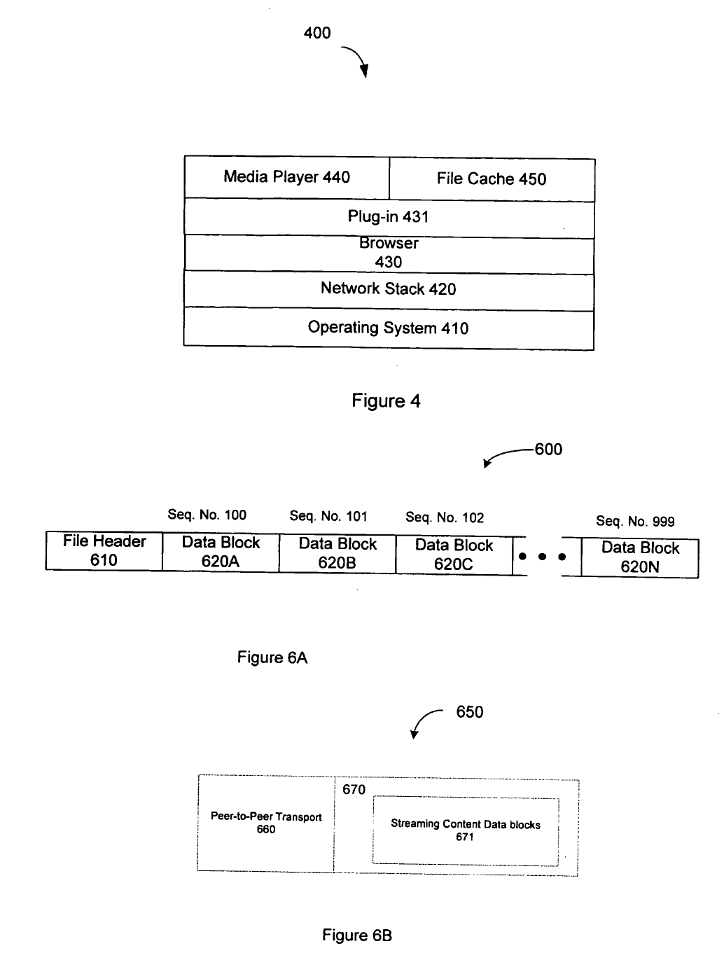

FIG. 4 is a diagrammatic representation of an embodiment of a software configuration 400 that facilitates streaming content operation in peer-to-peer network 101. Software configuration 400 comprises sets of computer-executable instructions or code that may be fetched from a memory and executed by a processing unit of a data processing system. Software configuration 400 provides peer-to-peer functionality for a client to operate within a peer-to-peer network 101 shown in FIG. 1.

Software configuration 400 may include an operating system 410, a network stack 420, a browser 430 application, and a media player 440 each similarly adapted as respective operating system 210, network stack 220, browser 230 application, and media player 240 described above in FIG. 2.

Additionally, software configuration 400 includes plug-in 431 comprising logic for interfacing and extending the functionality of browser 430. In a preferred embodiment, plug-in 431 provides peer-to-peer functionality for transmitting and receiving data to and from clients of peer-to-peer network 101 and for processing streaming content for transmission, reception, and playback within peer-to-peer network 101. Plug-in 431 may comprise computer-readable instructions installed on a client, such as client 180, in response to invocation of plug-in code. Plug-in code for installation of plug-in 431 may be transmitted to a network client by, for example, embedding the plug-in code in a web page that is transferred to a client and is processed by a browser application thereof. Plug-in 431 may, for example, be invoked by processing of plug-in code 320 of data structure 300 implemented as a web page. Software configuration 400 may additionally include a file cache 450 that may be interfaced by, for example, browser 430 and plug-in 431.

Plug-in 431 is preferably coded with logic for joining the client with peer-to-peer network 101 upon invocation of plug-in 431. For example, plug-in 431 may include connectivity information of control server 131 and logic for establishing a connection with control server 131 for joining peer-to-peer network 101. In a preferred embodiment, plug-in 431, upon invocation, connects with control server 131 and requests peer list 170 therefrom. Upon receipt of peer list 170, plug-in 431 may select one or more nodes having connectivity information identified in peer list 170 and connect with the selected nodes. Client 180 is then configured as a peer client of peer-to-peer network 101 and may participate in transmitting data to other peer clients and receiving data from other peer clients.

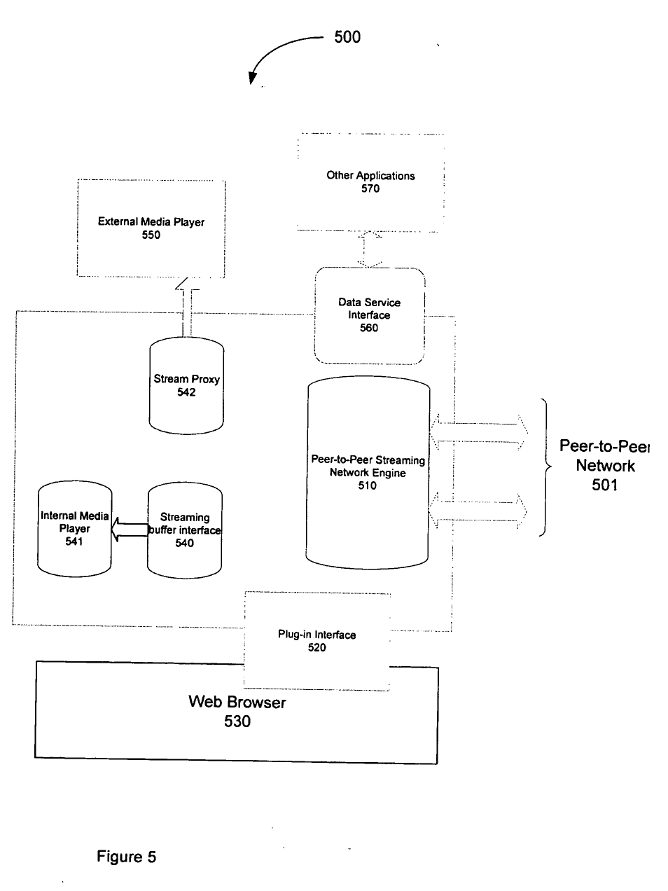

FIG. 5 is a diagrammatic representation of an embodiment of a plug-in configuration 500 that facilitates streaming content operation in a peer-to-peer network. Plug-in configuration 500 is an example implementation of plug-in 431 shown in FIG. 4. Plug-in configuration 500 includes a peer-to-peer streaming network engine 510 that facilitates delivery of streaming content to nodes of a peer-to-peer network and receipt of streaming content from nodes of a peer-to-peer network. For example, streaming network engine 510 may be adapted to deliver streaming content data blocks to one or more peer clients of peer-to-peer network 101 and for receiving streaming content data blocks from peer clients of peer-to-peer network 101. Thus, streaming network engine 510 provides a streaming interface to peer-to-peer network 101.

Streaming network engine 510 may comprise functionality for parsing or otherwise retrieving streaming content from a peer-to-peer network transport format used for delivery of streaming content within peer-to-peer network. For example, streaming content may be encoded in a native streaming format, such as Real Audio, Real Video, advanced streaming format (ASF), or another streaming format. The streaming content may be encapsulated in peer-to-peer network formatted frames for delivery in peer-to-peer network 101. To facilitate playback of the streaming content, streaming network engine 510 may be adapted to parse the streaming content from the network transport format data packets received from network 101 and assemble the parsed streaming content into the native format of the streaming content. Moreover, streaming network engine 510 may be adapted to organize parsed streaming content into a proper sequence. Streaming network engine 510 may process received streaming content for playback by a media player, such as an internal media player 541 adapted to process streaming content. In one implementation, streaming network engine 510 may write received streaming content data blocks to a streaming buffer interface 540 from which internal media player 541 may fetch streaming content for playback. The assembled streaming content may be written to streaming buffer interface 540 in its native format by streaming network engine 510. Internal media player 541 may then fetch the streaming content and process the streaming content for playback.

Additionally, streaming network engine 510 may fetch streaming content from a local storage, such as file cache 450 and format the streaming content for transmission to a peer client in peer-to-peer network 101. For example, streaming network engine 510 may fetch native formatted streaming content from file cache 450 and encapsulate the streaming content in peer-to-peer network transport formatted frames. The network transport formatted frames may then be conveyed to one or more peer nodes of peer-to-peer network 101.

Plug-in configuration 500 may include a plug-in interface 520 to a web browser 530 for display of processed data in web browser 530. For example, streaming content processed by internal media player 541 may be conveyed to web browser via plug-in interface 520. Web browser 530 may then display the processed streaming content in a graphical user interface thereof.

Additionally, plug-in configuration 500 may include a stream proxy module 542 that interfaces with an external media player 550, such as an instance of RealPlayer, Windows Media Player, or another media application. For example, streaming content received by streaming network engine 510 and processed thereby may be conveyed to stream proxy module 542 and provided to external media player 550. Thus, a media player application that is external to plug-in configuration 500 may playback streaming content that is delivered to the client by way of peer-to-peer network 101. Plug-in configuration 500 may additionally include a data service interface 560 for supplying (or receiving) other data received by (or transmitted to) peer-to-peer network 101.

FIG. 6A is a diagrammatic representation of an embodiment of segmented streaming content 600. Segmented streaming content 600 may be generated by streaming source 132 by segmenting or otherwise dividing streaming content into segments or data blocks. For example, the streaming source may extract a file header 610 from a streaming content file and store the extracted information as a file header block 610 in a cache or other storage device. Additionally, streaming source 132 may partition or otherwise segment streaming content into groups of one or more data blocks.

Groups of data blocks may then be transmitted to peers connected with streaming source 132, and streaming source 132 may store data blocks 620A-620N in a local storage device. In one embodiment, one or more data blocks 620A-620N of streaming content may be encapsulated into respective network transport formatted frames for deliver in peer-to-peer network 101. FIG. 6B is a diagrammatic representation of an embodiment of segmented streaming content encapsulated in a peer-to-peer transport packet 650, or data block, that may be distributed within peer-to-peer network 101. Peer-to-peer transport packet 650 may include a transport header 660 or other field that may contain parameters that facilitate delivery and processing of data in peer-to-peer network 101. Peer-to-peer transport packet 650 may include a payload field 670 in which one or more streaming content data blocks 671 may be inserted. Payload field 320 may be of a fixed or dynamic length. Accordingly, streaming source 132 may generate a sequence of transport packets 650 that each respectively includes one or more streaming content data blocks that each comprising streaming data segmented from a streaming data source, such as a streaming source file or streaming source produced by an audio/video production equipment. The streaming content inserted into payload field 670 preferably comprises streaming content in a native streaming content format, e.g. ASF, RealAudio, RealVideo, or the like. Thus, peer-to-peer transport packet 650 provides a mechanism for distribution of streaming content within peer-to-peer network 101.

A plug-in, on receipt of transport packet 650 is adapted to parse streaming content data blocks 671 from transport packet 650 and assemble the parsed data blocks into a streaming content data structure in the native format of the streaming content. The parsed streaming content may then be played back by the plug-in or stored in a file cache for later delivery to other peer clients. When a plug-in retrieves stored streaming content for delivery to other peer clients, the plug-in may perform segmentation of the streaming content (if required) and encapsulate the streaming content into one or more network transport formatted data packets similar to transport packet 650 for delivery to the peer clients.

Preferably, streaming source 132 associates a respective sequence number with each data block of the streaming content. For example, streaming source 132 may insert, append, or otherwise associate one of a series of sequence numbers to each data block 620A-620N of segmented streaming content 600. In the illustrative example, each of data blocks 620A-620N have a respective sequence number 100-999 associated therewith.

A peer client plug-in first receives file header block 610 prior to being able to playback any streaming content received in data blocks 620A-620N. One or more of data blocks 620A-620N may be received by the client, cached thereby, and assembled into sequential order based on data block sequence numbers for playback of the streaming content. Additionally, a plug-in may cache one or more received data blocks 620A-620N for later transmission to other peer clients requesting the streaming content. Once streaming content 600 (or a portion thereof) is delivered to one or more peer clients in peer-to-peer network 101, the one or more clients may cache the streaming content and distribute the streaming content to other peer clients.

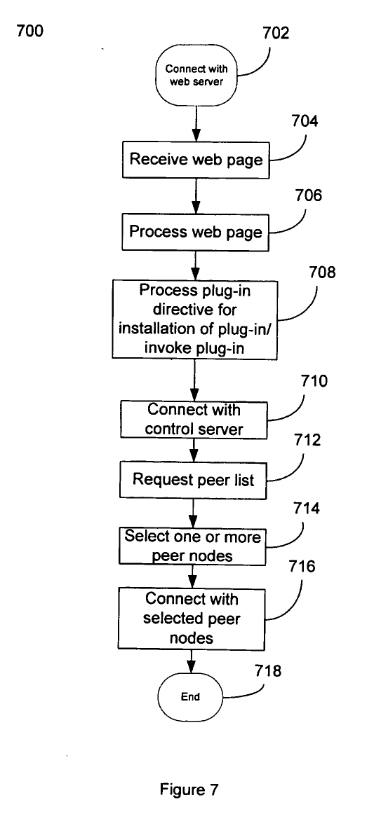

FIG. 7 is a flowchart of a configuration processing routine for configuring a network client as a peer client adapted for streaming content operation in peer-to-peer network 101. Network client 180 connects with web server 190 (step 702), and receives data structure 300, such as a web page, therefrom (Step 704). The network client then processes the web page (step 706). For example, web browser 430 run by network client 180 may process the downloaded web page. The browser may process a directive or control code within web page content 310 that provides instructions to invoke plug-in code 320 within the web page (step 708). Plug-in code 320 is then parsed from data structure 300 (in the event the plug-in is not installed), installed, and the plug-in is then invoked. Plug-in 431 then connects with control server 131 (step 710), and submits a request for peer list 170 to control server 131 (step 712). Plug-in 431 then selects one or more peer nodes from peer list 170 (step 714), and connects with the selected peer node(s) (Step 716). The network client is then configured as a peer node of peer-to-peer network 101 and the configuration processing routine may end (step 718). The client, now configured as a peer node of peer-to-peer network 101 may begin transmitting data to other peer nodes, receiving data therefrom, and process streaming content received within peer-to-peer network 101.

Embodiments described herein provide mechanisms for configuration of a network client as a peer client of a peer-to-peer network. A network client may obtain a web page or other data structure that includes plug-in code that is invoked during processing of the web page. The plug-in connects with a control server of a peer-to-peer network when invoked and obtains a peer list of peer client connectivity information. The plug-in the selects and connects with one or more of the peer clients identified in the peer list. The plug-in includes logic for transferring data in the peer-to-peer network to and from peer clients. Additionally, the plug-in includes logic for processing streaming content delivered in the peer-to-peer network.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of configuring a network client as a peer client in a peer-to-peer network, comprising:
connecting with a network node;
obtaining a data structure that includes plug-in code;
installing a plug-in from the plug-in code in the event the plug-in not installed;
connecting, by the plug-in, with a control server of the peer-to-peer network;
receiving connectivity information of one or more nodes of the peer-to-peer network; and
connecting, by the plug-in, with at least one of the one or more nodes.

2. The method of claim 1, wherein obtaining a data structure further comprises obtaining a web page with the plug-in code embedded therein.

3. The method of claim 1, wherein receiving connectivity information further comprises receiving a peer list having the connectivity information of the one or more nodes.

4. The method of claim 1, further comprising processing the data structure by a web browser, wherein installing the plug-in is performed in response to the browser encountering a directive for installing the plug-in in the web page.

5. The method of claim 1, wherein the plug-in is implemented as at least one of an ActiveX plug-in, a Java Applet plug-in, and an XPCOM plug-in.

6. The method of claim 1, further comprising:
receiving, by the plug-in, streaming content from one or more peer clients of the peer-to-peer network; and
processing, by the plug-in, the streaming content for playback of the streaming content.

7. The method of claim 1, further comprising:
receiving, by the plug-in, streaming content from one or more peer clients of the peer-to-peer network; and
storing, by the plug-in, the streaming content in a local file cache.

8. The method of claim 7, further comprising:
retrieving the streaming content from the local file cache; and
encapsulating the streaming content in one or more packets formatted for delivery in the peer-to-peer network.

9. The method of claim 8, further comprising transmitting the one or more packets to a node in the peer-to-peer network.

10. A computer-readable medium having computer-executable instructions for execution by a processing system, the computer-executable instructions for facilitating streaming content operation in a peer-to-peer network, comprising:
instructions that connect with a network node;
instructions that obtain a data structure that includes plug-in code from the network node;
instructions that install a plug-in from the plug-in code in the event the plug-in is not installed;
instructions that connect, by the plug-in, with a control server of the peer-to-peer network;
instructions that receive connectivity information of one or more nodes of the peer-to-peer network; and
instructions that connect with at least one of the one or more nodes.

11. The computer-readable medium of claim 10, wherein the instructions that obtain the data structure further comprise instructions that obtain a web page with the plug-in code embedded therein.

12. The computer-readable medium of claim 10, wherein the instructions that receive connectivity information further comprise instructions that receive a peer list having the connectivity information of the one or more nodes.

13. The computer-readable medium of claim 10, further comprising instructions of a web browser that process the data structure, wherein the instructions that install the plug-in are executed in response to the browser encountering a directive for installing the plug-in in the web page.

14. The computer-readable medium of claim 10, wherein the plug-in is implemented as at least one of an ActiveX plug-in, a Java Applet plug-in, and an XPCOM plug-in.

15. The computer-readable medium of claim 10, further comprising:
instructions of the plug-in that receive streaming content from one or more peer clients of the peer-to-peer network; and
instructions of the plug-in that process the streaming content for playback of the streaming content.

16. The computer-readable medium of claim 10, further comprising:
instructions of the plug-in that receive streaming content from one or more peer clients of the peer-to-peer network; and
instructions of the plug-in that store the streaming content in a local file cache.

17. The computer-readable medium of claim 16, further comprising:
instructions of the plug-in that retrieve the streaming content from the local file cache; and
instructions of the plug-in that encapsulate the streaming content in one or more packets formatted for delivery in the peer-to-peer network.

18. The computer-readable medium of claim 17, further comprising instructions of the plug-in that transmit the one or more packets to a node in the peer-to-peer network.

19. A data processing system for distributing and processing streaming content in a peer-to-peer network, comprising:
a memory that contains a set of instructions;
a network adapter that interfaces with a communications medium; and
a processing unit that, responsive to execution of the sets of instructions, connects the data processing system with a network node, downloads a data structure from the network node, installs a plug-in from code in the data structure in the event the plug-in is not installed, and, in response to invocation of the plug-in, connects with a peer-to-peer network.

20. The data processing system of claim 19, wherein the data structure comprises a web page, and wherein the plug-in initiates a connection with the peer-to-peer network by connecting with a control server of the peer-to-peer network and obtains connectivity information of one or more clients of the peer-to-peer network from the control server.

21. The data processing system of claim 19, wherein the plug-in is adapted to transfer data to nodes of the peer-to-peer network and to receive data from the nodes of the peer-to-peer network.

22. The data processing system of claim 21, wherein the data comprises streaming content and the plug-in is adapted to playback the streaming content received from the nodes.

23. The data processing system of claim 21, wherein the data comprises streaming content and the plug-in is adapted to store in a local file cache the streaming content received from the nodes.

24. The data processing system of claim 23, wherein the plug-in is adapted to retrieve the streaming content from the local file cache and transmit the streaming content retrieved from the local cache to the nodes.
